(19) United States
(12) Patent Application Publication
(10) Pub. No.: US 2019/0382315 A1
(43) Pub. Date: Dec. 19, 2019

(54) FUSED AND CRUSHED THERMAL COATING POWDER, SYSTEM FOR PROVIDING THERMAL SPRAY COATING, AND ASSOCIATED METHOD

(71) Applicants: Liming Zhang, Greenville, SC (US); James Edward Viggiani, Greenville, SC (US); Ying Zhou, Qinhuangdao City (CN); General Electric Company, Schenectady, NY (US)

(72) Inventors: Liming Zhang, Greer, SC (US); James Edward Viggiani, Greenville, SC (US); Ying Zhou, Qinhuangdao City (CN)

(21) Appl. No.: 16/477,360

(22) PCT Filed: Feb. 2, 2017
(86) PCT No.: PCT/CN2017/072802

§ 371 Date: Jul. 11, 2019

(51) Int. Cl. C04B 35/486; C04B 35/04; C23C 4/11; C23C 4/134; B05B 7/22

(52) U.S. Cl. CPC C04B 35/486; C04B 35/04; C23C 4/11; C23C 4/134; B05B 7/226; C04B 2235/3217; C04B 2235/3225; C04B 2235/3232; C04B 2235/3244; C04B 2235/3208; C04B 2235/3206; C04B 2235/528

(57) ABSTRACT

Various embodiments of the disclosure include a thermal coating powder, a system for providing a thermal spray coating, and a method for coating a component. The thermal coating powder may include fused and crushed yttria-stabilized zirconia, wherein the thermal coating powder is in a form of substantially spherically-shaped, solid particles. The system may comprise: a plasma spray gun apparatus having an exit annulus for releasing a plasma jet stream; and a powder injector port coupled to the plasma spray gun apparatus for supplying the thermal coating powder to the plasma jet stream. The method may include: providing a plasma spray gun apparatus including an exit annulus for releasing a plasma jet stream; and spraying the thermal coating powder on the component with the plasma jet stream from the plasma spray gun apparatus.

### BACKGROUND OF THE INVENTION

The disclosure relates generally to thermal coating powders, or more specifically, to fused and crushed thermal coating powders, systems for providing thermal spray coatings, and associated methods for coating components using thermal coating powders.

Thermal spraying is a coating method wherein powder or other feedstock material (e.g., metals, ceramics, etc.) is fed into a stream of heated gas produced by a plasmatron or by the combustion of fuel gasses, for application on a component. The hot gas stream entrains the feedstock to which it transfers heat and momentum. The heated feedstock is further impacted onto a surface of the component, where it adheres and solidifies, forming a thermally sprayed coating composed of thin layers or lamellae.

One common method of thermal spraying is plasma spraying. Plasma spraying is typically performed by a plasma torch or gun, which uses a plasma jet to heat or melt the feedstock before propelling it toward a desired surface. Current materials used for plasma spraying include powders in the form of hollow particles. As power levels of the plasma gun exceed 100 kilo Watts (kW), over-heating is often observed for hollow powders which causes cracking of the coating and results in lower adhesion properties.

### BRIEF DESCRIPTION OF THE INVENTION

Embodiments of the disclosure may include a thermal coating powder. The thermal coating powder may include: fused and crushed yttria-stabilized zirconia, wherein the thermal coating powder is in a form of substantially spherically-shaped, solid particles.

Embodiments of the disclosure may also include a system for providing a thermal spray coating. The system may comprise: a plasma spray gun apparatus having an exit annulus for releasing a plasma jet stream; and a powder injector port coupled to the plasma spray gun apparatus for supplying a thermal coating powder to the plasma jet stream, wherein the thermal coating powder includes fused and crushed yttria-stabilized zirconia and wherein the thermal coating powder is in a form of substantially spherically-shaped particles.

Embodiments of the disclosure may also include a method for coating a component. The method may comprise: providing a plasma spray gun apparatus including an exit annulus for releasing a plasma jet stream; and spraying a thermal coating powder on the component with the plasma jet stream from the plasma spray gun apparatus, wherein the thermal coating powder includes fused and crushed yttria-stabilized zirconia and wherein the thermal coating powder is in a form of substantially spherically-shaped particles

### BRIEF DESCRIPTION OF THE DRAWINGS

These and other features of the disclosure will be more readily understood from the following detailed description of the various aspects of the disclosure taken in conjunction with the accompanying drawings that depict various aspects of the disclosure.

FIG. 1 shows a shows a side view of a plasma spray gun system.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be used and that changes may be made without departing from the scope of the present teachings. The following description is, therefore, merely exemplary.

The disclosure relates generally to thermal coating powders, or more specifically, to fused and crushed thermal coating powders, systems for providing thermal spray coatings, and associated methods for coating components using thermal coating powders. In contrast to conventional thermal coating powders, e.g. hollow and spherically-shaped powders, the present disclosure provides for thermal coating powders comprising fused and crushed yttria-stabilized zirconia, wherein the thermal coating powder is in a form of substantially spherically-shaped, solid particles. The thermal coating powders discussed herein provide for increased deposition rates, better coating properties, and increased tensile strength and strain tolerance.

The thermal coating powder according to embodiments of the disclosure may include yttria-stabilized zirconia. The yttria-stabilized zirconia may include approximately 91 to approximately 93 weight percent zirconium oxide and approximately 7 to approximately 9 weight percent yttria oxide. In some embodiments, the yttria-stablized zirconia may also include a stabilizer. The stabilizer may include at least one of: calcium oxide, aluminum oxide, silicon oxide, titanium oxide, hafnium oxide, or other oxides. For example, the yttria-stablized zirconia may include at least one of: approximately 0.0 weight percent to approximately 0.7 weight percent aluminum oxide, or more specifically, approximately 0.13 weight percent aluminum oxide; approximately 0.0 to approximately 1.5 weight percent silicon oxide, or more specifically, approximately 0.18 weight percent silicon oxide; approximately 0.0 to approximately 0.5 weight percent titanium oxide, or more specifically, approximately 0.07 weight percent titanium oxide; approximately 0.0 to approximately 2.5 weight percent hafnium oxide, or more specifically, less than approximately 1.86 weight percent hafnium oxide; approximately 0.0 to approximately 0.5 weight percent iron oxide, or more specifically, approximately 0.02 weight percent iron oxide; or less than approximately 1.5 weight percent other oxide (such as for example, calcium oxide). Further, the yttria-stablized zirconia may optionally include other organic solids in the amount up to approximately 2.5 weight percent. As used herein, “approximately” is intended to include values, for example, within 10% of the stated values.

The yttria-stabilized zirconia thermal coating powder according to the present disclosure may be in the form of fused and crushed powder. “Fused and crushed powder” as used herein may refer to powder that is formed from a fused solid mass containing the desired raw materials, which is crushed to the appropriate particle size. Specifically, the raw materials, e.g., zirconium oxide and yttria oxide, may be provided in the same weight percentages as desired in their final compositions. The raw materials may undergo a fusing process, e.g., sintering, in order to form a fused solid mass. The solid mass may be mechanically crushed to form dense particles or microstructures. As a result, the particles which make up the thermal coating powder described herein are solid, not hollow. The particles may also undergo a plasma spheroidization process such that the particles of the thermal coating powder are substantially spherically-shaped. As used herein, “substantially” refers to largely, for the most part, entirely specified or any slight deviation which provides the same technical benefits of the disclosure. The plasma spheroidization process may include heating and melting the crushed particles. Subsequently, molten spherical droplets may be formed and cooled under free fall conditions. The resulting particles of the thermal coating powder may have a diameter of approximately 10 microns to approximately 100 microns, or more specifically, approximately 40 microns. The thermal coating powders discussed herein provide for increased deposition rates, better coating properties and life, including improved dense vertical coating, improved adhesion, less cracking, and increased tensile strength and strain tolerance. Conventional hollow powders used in high energy systems result in the powder and/or coating overheating and causes horizontal cracking. The thermal coating powder of the present disclosure provides greater density of the particles which achieves these benefits in high energy systems.

The thermal coating powders described herein may be provided or sprayed on a component desired to be coated by a plasma spray gun system. The plasma spray gun system may include, for example, the plasma spray gun systems described in U.S. Pat. No. 8,237,079, issued on Aug. 7, 2012, and/or U.S. Pat. No. 9,272,360, issued on Mar. 1, 2016, each of which are incorporated by reference herein in their entirety. A general description of an exemplary plasma spray gun system is provided herein. However, it is to be understood that the thermal coating powder described herein may be used with any thermal spray coating system or apparatus without departing from aspects of the disclosure described herein. In some embodiments, the thermal coating powder described herein can be used with a thermal spray coating system using a power level greater than or equal to approximately 100 kilo Watts (kW).

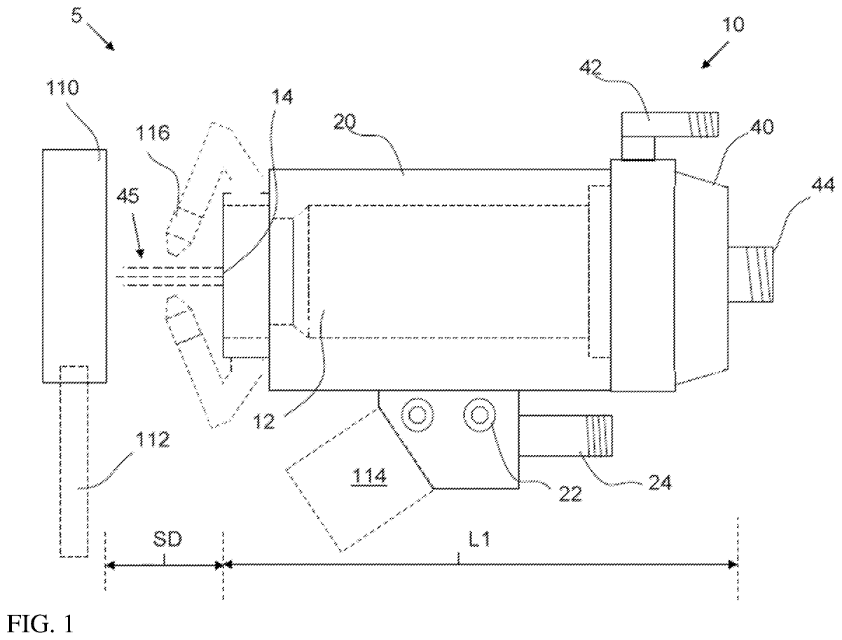

Turning to FIG. 1, a plasma spray gun system 5 is shown including an adjustable plasma spray gun apparatus 10, a component 110, a component holder 112 (shown in phantom), a robotic arm 114 (shown in phantom) and one or more injector ports 116 (shown in phantom). Adjustable plasma spray gun apparatus 10 may include a plasma spray gun body 20, which may hold a plasma spray gun nozzle 12 (shown in phantom). Plasma spray gun body 20 and plasma spray gun nozzle 12 may share an exit annulus 14, and may be electrically connected. Plasma spray gun body 20 may further include one or more mounts 22 for attaching to robotic arm 114, and a port 24 for receiving and/or expelling water from an external source (not shown). Port 24 may also connect to an external electric power supply (not shown). Plasma spray gun body 20 may be removably attached to an electrode body 40 at one portion, however, plasma spray gun body 20 is electrically insulated from the electrode housed within electrode body. Electrode body 40 may include a plasma gas port 42 for receiving a plasma gas from an external source (not shown), and a port 44 for receiving and/or expelling water from an external source (not shown). Port 44 may also connect to an external electric power supply (not shown). Descriptions of external water, electric power and gas supplies, as well as cooling systems, are omitted herein, and function substantially similarly to those known in the art. Plasma spray gun apparatus 10 may have a length L1, which may include the distance from approximately the aft end of electrode (farthest end from component 110) to exit annulus 14. The distance between exit annulus 14 and component 110 is shown as the standoff distance SD. As further described herein and illustrated in the FIGURES, plasma spray gun system 5 may allow for spraying one or more components 110 at different power levels while maintaining a fixed standoff distance SD. Component 110 may include, e.g., a hot gas path component (e.g., joints, surfaces, conduits, interior diameters, etc.) within a machine.

During operation of plasma spray gun system 5, an arc is formed inside electrode body 40 and plasma spray gun body 20, where electrode body 40 acts as a cathode electrode and plasma spray gun body 20 acts as an anode. Plasma gas is fed through plasma gas port 42, and extends the arc to exit annulus 14, where injector ports 116 may supply the thermal coating powders described herein from a powder feeder or powder supply (not shown) into a plasma jet stream 45 as it leaves plasma spray gun body 20 and plasma spray gun nozzle 12 via exit annulus 14. Injector ports 116 may allow for radial supply of the thermal coating powder into plasma jet stream 45. Plasma jet stream 45, including thermal coating powder, is then propelled toward component 110, thereby coating it. Standoff distance SD is designed so as to optimize spraying conditions for a particular component 110.

Embodiments of the disclosure also include a method for coating component 110. The method may include: providing plasma spray gun apparatus 10 including exit annulus 14 for releasing plasma jet stream 45; and spraying the thermal coating powder on component 110 with plasma jet stream 45 from plasma spray gun apparatus 10. The spraying may form a thermal barrier coating on the component with multi-vertical cracking, greater adhesion properties, and increased strain tolerance.

Where an element or layer is referred to as being “on,” “engaged to,” “disengaged from,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A thermal coating powder comprising fused and crushed yttria-stabilized zirconia, wherein the thermal coating powder is in a form of substantially spherically-shaped, solid particles.

2. The particle composition of claim 1, wherein the fused and crushed yttria-stabilized zirconia includes:
approximately 91 to approximately 93 weight percent zirconium oxide; and
approximately 7 to approximately 9 weight percent yttria oxide.

3. The particle composition of claim 2, wherein the fused and crushed yttria-stabilized zirconia further includes at least one of: calcium oxide, aluminum oxide, silicon oxide, titanium oxide, hafnium oxide, iron, or magnesium oxide.

4. The particle composition of claim 1, wherein the substantially spherically-shaped, solid particles have a diameter of approximately 40 microns.

5. A system for providing a thermal spray coating, the system comprising:
a plasma spray gun apparatus having an exit annulus for releasing a plasma jet stream; and
a powder injector port coupled to the plasma spray gun apparatus for supplying a thermal coating powder to the plasma jet stream,
wherein the thermal coating powder includes fused and crushed yttria-stabilized zirconia and wherein the thermal coating powder is in a form of substantially spherically-shaped particles.

6. The system of claim 5, wherein the fused and crushed yttria-stabilized zirconia includes:
approximately 91 to approximately 93 weight percent zirconium oxide; and
approximately 7 to approximately 9 weight percent yttria oxide.

7. The system of claim 6, wherein the fused and crushed yttria-stabilized zirconia further includes at least one of: calcium oxide, aluminum oxide, silicon oxide, titanium oxide, hafnium oxide, iron, or magnesium oxide.

8. The system of claim 5, wherein the substantially spherically-shaped particles include a diameter of approximately 40 microns.

9. The system of claim 5, wherein the substantially spherically-shaped particles are solid.

10. The system of claim 5, wherein the plasma spray gun apparatus includes a power energy level greater than or equal to approximately 100 kilo Watts (kW).

11. A method for coating a component, the method comprising:
providing a plasma spray gun apparatus for releasing a plasma jet stream; and
spraying a thermal coating powder on the component with the plasma jet stream from the plasma spray gun apparatus,
wherein the thermal coating powder includes fused and crushed yttria-stabilized zirconia and wherein the thermal coating powder is in a form of substantially spherically-shaped particles.

12. The method of claim 11, wherein the fused and crushed yttria-stabilized zirconia includes:
approximately 91 to approximately 93 weight percent zirconium oxide; and
approximately 7 to approximately 9 weight percent yttria oxide.

13. The method of claim 12, wherein the fused and crushed yttria-stabilized zirconia further includes at least one of: calcium oxide, aluminum oxide, silicon oxide, titanium oxide, hafnium oxide, iron, or magnesium oxide.

14. The method of claim 11, wherein the substantially spherically-shaped particles have a diameter of approximately 40 microns.

15. The method of claim 11, wherein the substantially spherically-shaped particles are solid.

16. The method of claim 11, wherein the spraying includes using the plasma spray gun apparatus with a power energy level greater than or equal to approximately 100 kilo Watts (kW).

17. The method of claim 16, wherein the spraying forms a thermal barrier coating on the component with greater adhesion properties and increased strain tolerance.
